(19) United States
(12) Patent Application Publication
(10) Pub. No.: US 2023/0326189 A1
(43) Pub. Date: Oct. 12, 2023

(54) SYSTEM AND METHOD FOR GENERATING MACHINE PERCEPTIBLE DESIGNS FOR OBJECT RECOGNITION

(71) Applicant: Adam Silver, Seattle, WA (US)

(72) Inventor: Adam Silver, Seattle, WA (US)

(21) Appl. No.: 17/966,811

(22) Filed: Oct. 15, 2022

Related U.S. Application Data
(60) Provisional application No. 63/311,457, filed on Feb. 18, 2022.

(51) Int. Cl. G06V 10/776; G06V 10/774; G06V 20/70; G06V 10/764; G06V 10/82; G06T 11/60; G06T 3/40

(52) U.S. Cl. CPC G06V 10/776; G06V 10/774; G06V 20/70; G06V 10/764; G06V 10/82; G06T 11/60; G06T 3/40; G06T 2210/12

(57) ABSTRACT

A design is created that increases the likelihood of successful object identification of objects in a target class by a wide variety of object detectors when the design is applied to a physical instance of the class object. Methods for creation of the design comprise applying gradient descent on loss functions, derived from object identifiers operating on a test group of images of target class objects, employed iteratively to modify pixels in an inserted image workpiece until object identification of the workpiece is optimized, the workpiece thereby becoming the perceptible design. Articles of manufacture bearing the perceptible design are disclosed.

### CROSS-REFERENCE TO RELATED APPLICATION

This application claims the benefit of U.S. provisional patent application number 63/311,457, filed Feb. 2, 2022, incorporated herein by reference.

### BACKGROUND OF THE INVENTION

### Field of the Invention

This invention relates to object recognition functionality in computer systems. More specifically, this invention relates to the generation of designs for improving the performance of object recognition systems.

### Description of the Related Art

The field of artificial intelligence research and development has grown exponentially in recent years, owing in large part to the development of computer hardware supporting deep neural network technology. In this technology, artificial systems are configured to have the ability to develop mathematical relationships between input data and desired system responses.

In object recognition technologies, input data generally comprises an electronically encoded optical representation of a visual field. The technology employs iteration to develop relationships between optical input data and the presence of the representation of a specified object in such data to develop a functionality that enables the determination of the presence and location of such an object in a current visual field. Modern object recognition technology is successfully employed in wide ranging fields, from machine assisted and autonomous vehicle operation, to manufacturing quality control, medical diagnosis and face detection. By processing large datasets of visual information, these derived relationships can enable deep neural networks to approach the reliability of human visual recognition abilities.

Deep neural networks rely on structures that improve the reliability of their determination, or “learn”, though iterative processing of data, or “training”. Several technological developments, such as convolutional neural nets and transfer learning models implemented on advanced data processing hardware, have converged in recent years to provide a framework for increasingly reliable artificial image recognition.

The problem of object recognition is one of matching image data to an object label, for example matching region of the image containing that of a person to the label “person”. In object recognition training, the object label is abstracted to a target that identifies the region of the image. The image data used as input for neural network object recognition typically comprises matrices of pixels in a digitized representation of the target image. In the art, a typical input matrix comprises a 2-dimensional array of 3-tuple (triplet) elements, corresponding to the red, green and blue values of each pixel in the two-dimensional rendering of the image represented by the data.

Deep neural networks in object recognition rely on data processes that use multiple layers for progressively extracting higher level features starting with raw input of matrix data corresponding to an image containing a representation of the target. Layers in deep neural networks are comprised of interconnected artificial neurons capable of receiving and sending signals. Input matrix data is presented to the input layer in a neural network for further propagation and processing by successive connected layers.

In layers below the input layer, a given neuron in the network can receive an input signal from every neuron to which it is connected. Signals in deep neural networks used for object recognition are simply real number values. As described above, in the art these values are generally in the form of triplets, in correspondence with the pixel values provided to the input layer. For the given neuron, a weight is associated with the signal from each connected neuron. In operation, the given neuron accumulates the weighted signals from connected neurons, adding a bias value to the sum. The neuron then applies an advantageously selected non-linear function to the biased sum to produce an output signal. This operation is portrayed symbolically in Equation 1.

$$individual neuron behavior \qquad Equation 1$$

$$z = {\sum }_{n} {w}_{i} {x}_{i} = {w}^{T} \cdot x$$

$$\hat{y} = g ( z + b )$$

$$where :$$

$$z is the dot product of the weight \\ vector {w}_{i} and the input signal vector {x}_{i}$$

$$g is a non - linear function applied to sum z with bias b$$

$$\hat{y} is the output signal of the neuron$$

Neurons in turn are organized into layers within the neural network. A given layer receives input volume as a vector of signals from one or more preceding layers. This vector of signals is referred to as the activation of the preceding layer. By applying their individual weighting and bias to the preceding layer's activation, the neurons in the given layer generate a weighted bias vector to which a non-linear function, called an activation function, is applied to generate an output volume vector, which in turn is the activation for the given layer and provides input volume data for the succeeding layer of the neural network. This process is illustrated symbolically in Equation 2.

$$Equation 2 - processing by a neural network layer$$

$${z}_{i}^{[ q ]} = {w}_{i}^{T} \cdot {a}^{[ q - 1 ]} + {b}_{i}$$

$${a}_{i}^{[ q ]} = {g}^{q} ( {z}_{i}^{[ q ]} )$$

$$where :$$

$${a}^{[ q ]} is the activation vector for layer q$$

$${g}^{[ q ]} is the activation function for layer q$$

Training a neural network entails repeated iterations of signaling across layers of neurons. With each iteration, neural network processing alters the weight vector and the bias for each neuron. This training creates a learning model in the network, as further explained below.

Typical deep neural networks comprise many layers. The progression of data volume from higher layers to lower layers is referred to as forward propagation. When the data volume passes through the lowest level, an assessment of error is made by comparing the output volume to the image target. A loss function (sometimes called the “cost function”) is applied to compute a loss value based upon the difference between the value of the target and the value of the output. A typical loss function is shown in Equation 3

$$Loss function as mean squared error for n datapoints \qquad Equation 3$$

$$L = \frac{1}{n} \sum {( target - output )}^{2}$$

After applying a loss function to derive the loss value, the neural network typically performs a back propagation. In back propagation, levels are traversed in reverse order beginning at the lowest level. A combination of program and data structures are employed to determine which weights on each level contribute most to the loss value. This is equivalent to computing the loss gradient dL/dW over the current weighting values W on each layer.

Advantageously, a form of gradient descent is applied to the layers of the neural network in an effort to optimize performance by reducing the loss value. Application of gradient descent operations results in values for a parameter update that changes weighting in a direction opposite to that of the loss gradient, as illustrated symbolically in Equation 4.

$$Parameter update \qquad Equation 4$$

$$w = {w}_{0} - η \frac{d L}{dw}$$

$$where :$$

$$w is weight$$

$${w}_{0} is original weight$$

$$η is learning rate$$

The learning rate η is a value chosen by the programmer of the network. With higher learning rates, bigger steps are taken in weight updates and thus the learning model converges on an optimized set of weights quickly. However, if the learning rate is too high, large jumps in weight values between training iterations can result in a lack of precision that may cause the model to miss an optimal match between output and target.

A training iteration of the neural net typically comprises the processes of forward propagation, loss function computation, back propagation and parameter update. Training iteration is repeated to a local minimum of the loss gradient, and thereby the weights of the layers are sufficiently tuned to provide an acceptable loss value between the target image and the network output.

The network, now optimized for response with respect to a first set of input matrix data corresponding to one image of the target object, is next presented with another set of input matrix data corresponding to a different image containing the same target object, and the training process is repeated. With optimized tuning resulting from effective training with a sufficiently large variety of images of the target object and by applying an appropriate learning rate and loss function, a deep neural network can exhibit the ability accurately to identify objects in various configurations in a variety of visual environments.

However, prior art machine-implemented object recognition is not without error. A number of configurations of the object or the environment in the visual field can result a trained neural network to fail, either by mis-identifying an object or by failing to identify the object altogether. If an object cannot be perceived with sufficient clarity, an optimally configured object detector can fail to recognize the object. In specific applications, such as recognition of a pedestrian by an autonomous driving system, failures can have catastrophic consequences.

What is needed is a way of improving the accuracy of object identification by any trained neural network. What is needed further is a physical design that can be applied to an object that enhances the likelihood of successful identification and recognition of the object by the neural network. What is needed further is a means for generating such a design for a specific class of object, such as a person, across a wide range of object detectors, furthered by the growing adoption of transfer learning among various object detector architectures.

### SUMMARY OF THE INVENTION

For a particular class of object, a design is created that increases the likelihood of successful object identification by a wide variety of object detectors when the design is applied to a physical instance of the class object. The design thereby signals the object's identity to object detectors.

One embodiment of the present invention starts with a dataset of images of objects in the target class that are difficult to discern. Images in this dataset are obfuscated, either having been selected as obscured (for example, with subjects in fog or in shadow) or by manipulation of the images by processes such as folding, varying contrast, varying brightness, inserting noise, changing tint or varying color saturation. Images of obfuscated objects in the target class are then identified and labeled as such by humans and assigned bounding boxes, each box indicating the presence of an image of a target class object, the collection of obscured, labeled and bounded images forming a test dataset. An additional starting image that is the workpiece of this invention is selected. The workpiece starting image may be a pre-existing image or may simply comprise random pixels.

Embodiments of the invention digitally combine the workpiece image with images in the test dataset, scaling the workpiece image to the size of each labeled image and placing the workpiece image at an appropriate position on the labelled image within the target object(s) bounding box. Depending on the target object, the position may vary. In an iteration, the resulting combination dataset is presented to one or more object detectors previously trained to recognize objects in the target class.

In each iteration, the likelihood that the target object has been found is then used to compute a loss function. In the case of multiple instances of a target object in a given test image the process can calculate a loss function based on factors including, but not limited to the average, minimum or maximum likelihood that the target object is present in one of the labeled bounding boxes. Advantageously, the loss function values are used to guide manipulation of pixels in the workpiece image for combination with the image dataset for subsequent iterations.

In one embodiment of the invention the loss function is calculated by multiplying the likelihood that the target object is present in the labeled bounding boxes by negative one. For multiple objects, this process is applied to a measure of the likelihood of object presence, which may be the median, maximum or average likelihood of presence, depending on embodiment. The loss function thus calculated can then be minimized in future iterations. Other factors, including total variation of pixels in the image and other, design-oriented parameters (e.g., similarity to a given target image or set of images, different measures of image simplicity and other potential desirable characteristics) can be included in the cost function. In different embodiments of the invention, these additional factors are multiplied by weights and added to the likelihood that the target object is present in the labeled bounding boxes.

In an embodiment of the present invention, the gradients of the pixel values in the workpiece image are computed with respect to the loss function. Applying gradient descent to minimize the loss gradient, embodiments of the invention modify pixels in the workpiece image. The modified workpiece is then combined with the test dataset as described above and the resulting combination dataset presented to the one or more object detectors in a new iteration. This process is repeatedly iterated to increase the likelihood (1) that the pixels in the workpiece image are optimized to maximize the likelihood that the target object(s) is perceived accurately by the object detector(s) and (2) that the resultant design meets any applicable appearance constraints (color, shape, similarity to a given target image or set of images, different measures of image simplicity or other potential desirable characteristics). In one embodiment of the present invention, iterations are complete once the likelihood that object detector perceives the target image accurately is maximized (no further improvements are seen). In other embodiments a fixed set of iterations may be declared in order to limit the time of process execution.

When the design resulting from the optimized manipulation of the workpiece image is applied to an object in the target class, the likelihood that a trained object detector will correctly locate and recognize the object is increased.

### BRIEF DESCRIPTION OF THE DRAWINGS

Objects of the present invention as well as advantages, features and characteristics, in addition to methods of operation, function of related elements of structure, and the combination of steps and economies and methods of manufacture, will become apparent upon consideration of the following description and claims with reference to the accompanying drawings, all of which form a part of this specification, wherein like reference numerals designate corresponding parts in the various figures, and wherein:

FIG. 1 is a flowchart of steps in creating a perceptible image in an embodiment of the invention;

FIG. 2a is a detailed flowchart of image classification, loss function computation and pixel optimization of the workpiece in an embodiment of the invention employing a plurality of object detectors;

FIG. 2b is a flowchart with additional detail regarding loss function computation and workpiece pixel optimization in an embodiment of the invention;

FIG. 3 is an exemplary photograph from among those comprising a dataset of images employed in an embodiment of the invention;

FIG. 4 is a detail of the two human figures in the photograph of FIG. 3, with added bounding boxes indicated;

FIG. 5a is a representative initial workpiece comprising a graphic design of random pixels used to fill in bounded areas in labeled photographs in an embodiment of the invention;

FIG. 5b is a variation of the initial workpiece depicted in FIG. 5a, created by one or more of affine transform, contrast variation, brightness variation and insertion of random noise in an embodiment of the invention;

FIG. 5c is another variation of the initial workpiece depicted in FIG. 5a in an embodiment of the invention;

FIG. 6 depicts the superimposition of workpiece designs within the bounding boxes of the figures depicted in the embodiment illustrated by FIGS. 3-4;

FIG. 7 depicts another exemplary photograph in a dataset of images in an embodiment, the figures in the photograph having added bounding boxes in which are superimposed workpiece designs;

FIG. 8 depicts iterative refinement of a workpiece in the practice of an embodiment of the invention, starting with random pixels and finishing with a perceptible design; and

FIG. 9 depicts an embodiment in which a perceptible design is affixed to an article of manufacture, in this case a t-shirt.

### DETAILED DESCRIPTION OF THE INVENTION

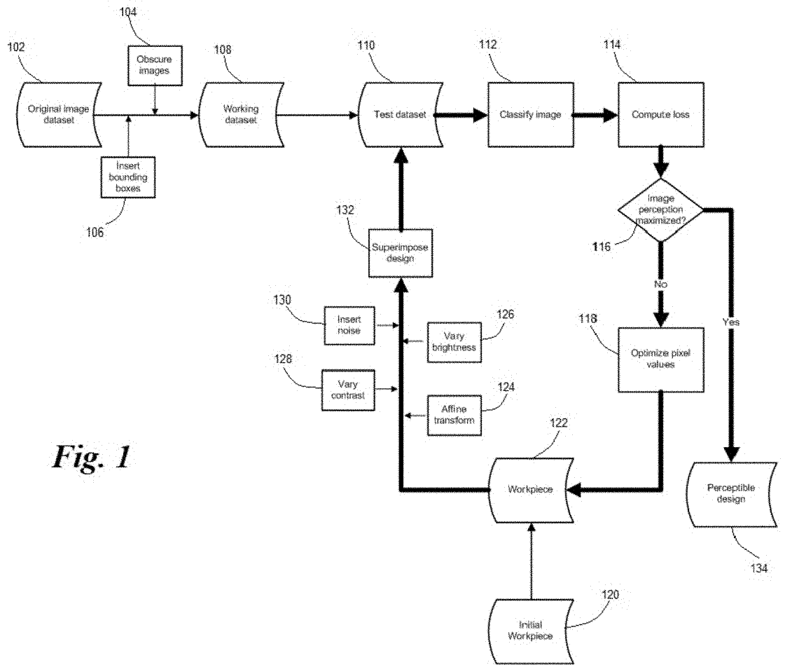

FIG. 1 is a simplified flowchart of the process whereby an original image dataset 102 is used iteratively to transform an initial graphic workpiece 120 into a perceptible design 134. Image dataset 102 comprises a plurality of labeled photographs, each such photograph containing obfuscated images of one or more objects to which the labeling pertains. In embodiments, some of the object images may be difficult to discern, because of lighting, contrast, orientation, etc. in the original dataset photograph. In embodiments, at least some of the images may be processed to be intentionally obscure 104, by operator alteration of brightness, contrast, tint, color saturation and other processes well known in the digital arts, which may have the effect of reducing the likelihood of detection of the altered image by an object detector. Bounding boxes 106 are placed on images of target objects in the photographs comprising the dataset. While it is well known in the art how automatically to insert a bounding box by way of object detection, because some images in the dataset may be obscured either originally or by intentional processing 104, the automatic object detection required for automatic bounding box insertion may not be possible and boxes may therefore require manual insertion 106 by human operators.

By taking an image dataset 102 of photographs, obscuring their images 104 and inserting bounding boxes 106, each box to designate the presence of a target object within the bounding box, a working or test dataset 108 is produced that is then employed by the invention to create a perceptible design 134 corresponding to the target object label. from an initial image workpiece 120.

Initial workpiece 120 may comprise any starting image. In embodiments, initial workpiece 120 is simply an image of random pixels. In any case, the invention iteratively processes and modifies workpiece 120 ultimately to result in perceptible design 134. In embodiments, in each iteration designs derived from the current iteration of workpiece 122, are scaled and inserted into the bounding boxes of the test dataset, as shown in step 132. Prior to insertion into each bounding box, embodiments may subject the current iteration of workpiece 122 to a series of random transformations, including affine transformation 124, brightness variation 126, contrast variation 128 and noise insertion 130 in mimicry of real world variability, in order to yield a resiliently perceptible final design.

Each image from the test dataset 110 resulting from the insertion 132 of designs based on the current iteration of workpiece 122 is then presented to one or more object detectors for image classification 112, in which the one or more object detectors then determine the likelihood that the target object is present within labeled bounding boxes. Based upon these results, a loss function is applied 114 to derive a loss value. In each iteration, the derived loss value is compared with those of previous iterations to determine whether the perception of the image as the target object has been maximized 116. If the current iteration has not optimized perception of the image, then gradient descent is applied to optimize pixel values 118 of workpiece 122 and a new iteration of the process is performed. This process is repeated until the system determines 116 that image perception of the workpiece has been optimized, in which case the workpiece is now the perceptible design 134 product of the invention.

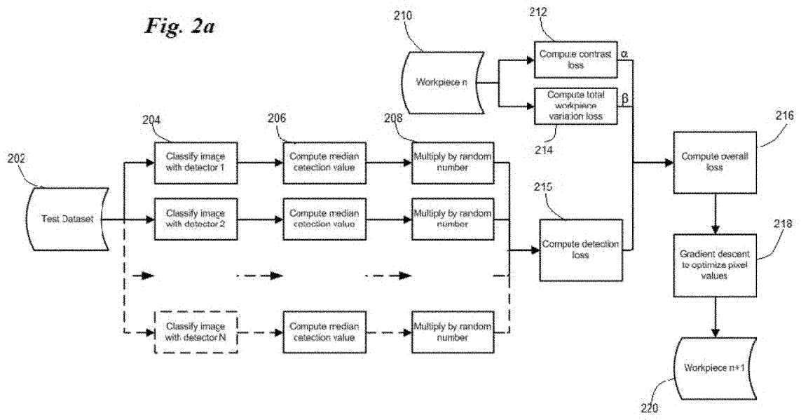

Turning to FIG. 2a, a flowchart represents detailed processing of test dataset images by a plurality of image detectors in an embodiment of the invention. The plurality of detectors classify 204 images from test dataset 202. Median values are computed 206 for likelihood of detection of the target object in images from dataset 202, thereby enabling the computation of detection loss over iterations. Because it is possible that certain features of the design may uniquely favor one detector over another, in this embodiment the median detection value from each object detector is then multiplied by a random number 208 thereby assuring that detection values from any particular object detector are not favored from iteration to iteration. In such embodiments, the randomized median detection values are what is used for computation of detection loss, L_{Detection}.

On completion of an iteration on workpiece(n) 210, contrast loss computation 212 is used to remove errant pixels in the reflective workpiece by minimizing the number of luminous pixels in the image, as illustrated symbolically in Equation 5 below, resulting in a value for luminosity loss, L_{Lum}.

$$Luminosity loss function \qquad Equation 5$$

$${L}_{Lum} = \frac{\sum [ p \neq 1 ]}{\vert p \vert}$$

$$where :$$

$${p}_{i} is 1 when pixel i is luminous \\ and \vert p \vert is the total pixels in the workpiece$$

Persons of skill in the art will also be acquainted with total variation loss computation 216, which can be applied to the current workpiece 210 to create a smoother overall image with less stark differences between pixels. Total variation loss, L_{TV}, is represented symbolically in Equation 6 below, illustrating the total variation over all pixels in image y.

$$Total pixel variation \qquad Equation 6$$

$${L}_{T v} = {\sum }_{i , j} ( \vert {y}_{i + 1 , j} - {y}_{i , j} \vert - \vert {y}_{i , j + 1 -} {y}_{i , j} \vert )$$

Empirically based weighting factors α and β are applied to the values for luminosity 212 and total variation 214 respectively. The values for α and β are chosen to conform the workpiece design to physical world constraints on reproducibility and production. While these weighting factors may vary widely, from 0.000 to 0.200 and above, embodiments have used values of 0.050 for α and 0.075 for β to good effect. Loss values with appropriate weighting are used to compute an overall loss value 216 (Equation 7), which is employed in gradient descent calculation 218 to optimize workpiece pixel values, creating a modified workpiece 220 for insertion in test dataset for another iteration.

L=L_{Detection}+αL_{Lum}+βL_{Tv}, Equation 7—Overall loss value

FIG. 2b provides detail of gradient descent calculation 218 with pixel optimization in an embodiment, transforming current workpiece(n) 210 into workpiece(n+1) 220 for use in the next iteration. Overall loss value 222 (Equation 7) from computation 216 (FIG. 2a) is used over a pixel by pixel loss function gradient calculation 218 acting on a workpiece image in progress 226 with pixel adjustment for loss optimization 230, until each pixel in the workpiece 226 has been modified, resulting in new workpiece(n+1) 220.

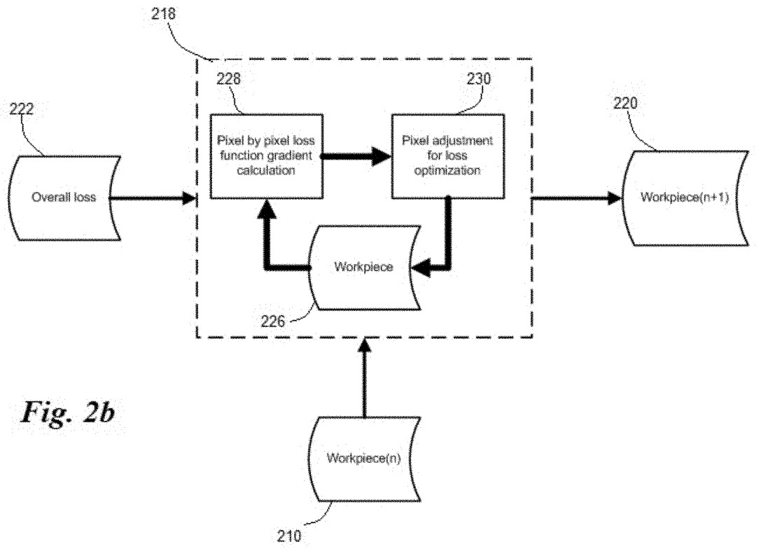

In embodiments, photographs of target objects may be chosen for inclusion in the test dataset based in part on difficulty of detection. Such photographs may have images of objects that are obscured, darkened, in unusual positions, and so forth as normally to present lower likelihood of detection by object detectors. FIG. 3 presents an example of such a photograph for a session of an embodiment in which the target object is a human, with images 302, 304 of people.

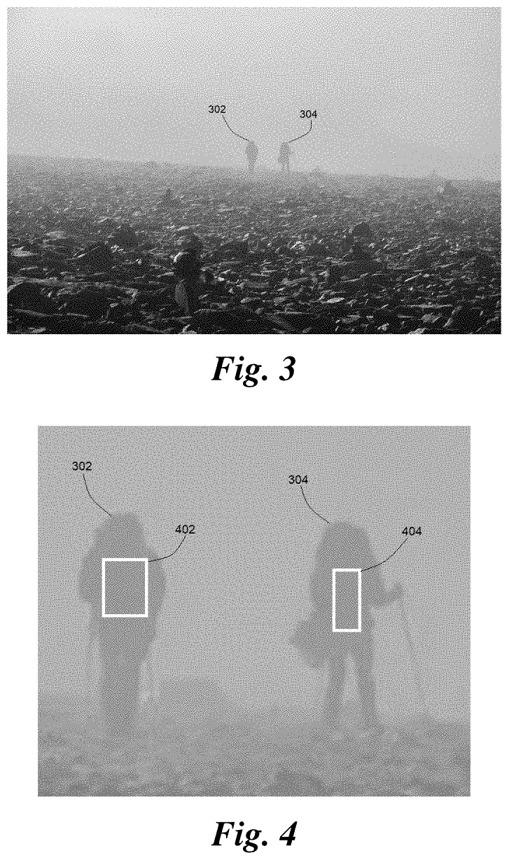

In embodiments, bounding boxes are inserted over images of target objects. FIG. 4 is a detail of the photograph from FIG. 3, showing bounding boxes 402, 404 inserted over images 302, 304 respectively. Because images for the test dataset may be intentionally selected to contain target objects that are difficult to detect, embodiments of the invention may use human operators to identify target objects in the original photographs and manually insert the required bounding boxes. Embodiments may also or alternatively employ automated methods initially to identify target objects and insert bounding boxes to create the test dataset.

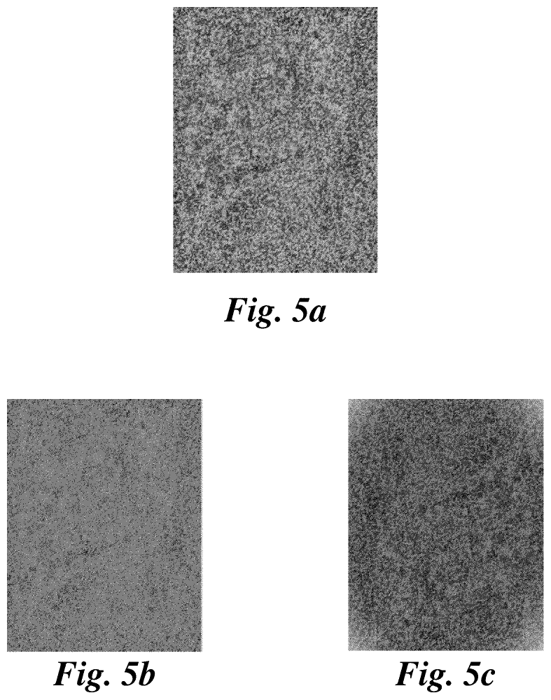

The initial workpiece of the invention may be simply an image of random pixels, such as depicted in FIG. 5a. In each iteration, the current workpiece or variations thereof are sized and inserted in bounding boxes in the images in the text dataset. Prior to insertion in each bounding box, however, embodiments may alter the current workpiece by affine transformation, contrast variation, brightness variation, noise insertion, rotation and such other adjustments and distortions known to those of skill in the art. Some such alterations of the workpiece of FIG. 5a are illustrated in FIGS. 5b and 5c. These alterations mimic the variation in appearance of a given design applied to real world objects in varied conditions and configurations.

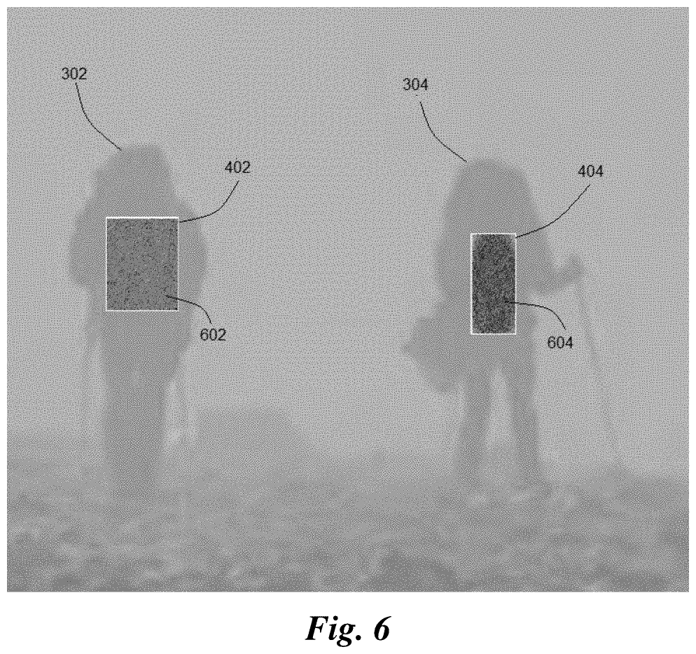

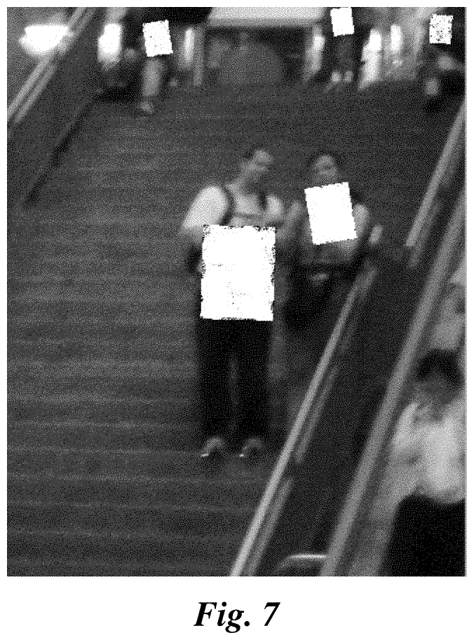

Turning now to FIG. 6, depicted is detail from the photograph depicted in FIG. 3, in which bounding boxes 402, 404 placed over images of target objects 302, 304 now contain the variations of the current workpiece 602, 604. FIG. 7 shows another photograph in which images of people are overlain with variations of a workpiece within bounding boxes. Each iteration of the process comprises a test dataset with such images containing the current workpiece, presented for image classification by one or more object detectors. Loss function computations based on the classification results enables modification of the workpiece with a goal of ultimately producing the perceptible design that this invention creates.

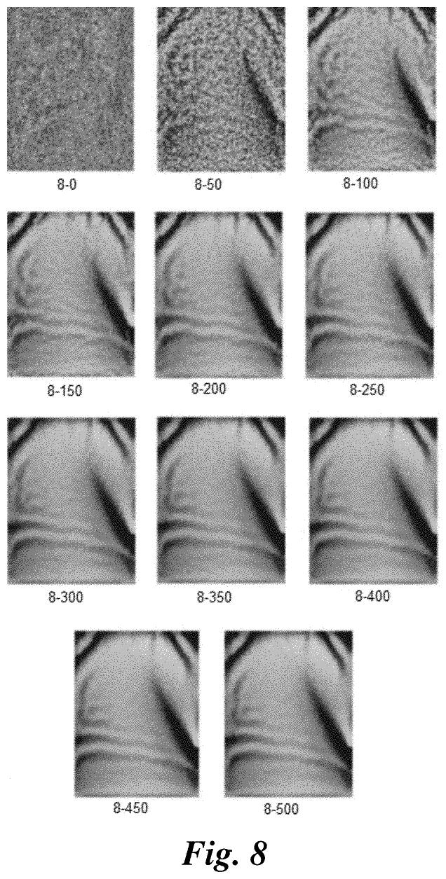

FIG. 8 shows development of the workpiece into a perceptible design over time, in 50 iteration increments in one embodiment. Going from an original workpiece comprised in this case of random pixels, 8-0, the workpiece is modified iteratively to result a design 8-500 that maximally enhances the probability of object detection when overlain on an image of the target object, even when the design is altered by angles, distances, brightness or noise. By employing a plurality of object detectors in the design creation process, embodiments can create perceptible designs that abstract the representation of the target object to be recognizable by object detectors generally regardless of underlying detector technology.

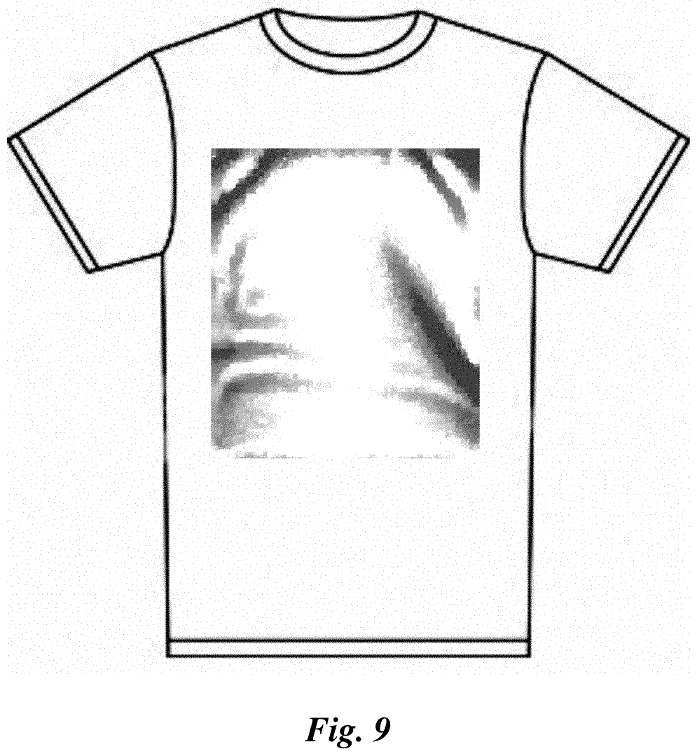

As autonomous machines are increasingly deployed in diverse areas such as transportation and manufacturing, persons of skill in the art will appreciate that improvements in object detection by machines will be enhanced by application of perceptible designs to articles of manufacture. FIG. 9 illustrates a t-shirt imprinted with a perceptible design. If the design is created according to the teachings of the present invention with a human as the target object, a wearer of the shirt is more likely to be identified as a person by object detectors employed in autonomous machinery, with obvious utility in machinery safety and reliability.

As will be appreciated by those in the art, perceptible designs made with the present invention have myriad applications in improving the accuracy of object detecting systems. A perceptible design can be placed on an object to aid machinery relying on accurate object detection under conditions in which the target object might otherwise be difficult to discern, such a low light, fog or smoke, or when the target object appears in an unexpected or unusual configuration. The design thus serves to label the object so that the object is recognized as such by object detectors in general under a wide variety of conditions. Yet further, the growing adoption of transfer learning among object detectors can serve only to increase the probability of detection of target objects displaying the perceptible design across the varied architectures.

While the invention has been described with a certain degree of particularity, a simplified description has been provided for the sake of clarity. It should be recognized that elements thereof may be altered by persons skilled in the art without departing from the invention's spirit and scope. For example, persons of skill in the art will understand that, while embodiments described have focused on luminosity values of images and datasets, the teachings of the present invention are applicable to the color aspects of representations as well. Embodiments may focus on RGB values instead of luminosity. In the iterative process of transforming the workpiece to the perceptible design in such embodiments, pixel optimization is applied to the three RGB pixel values instead of the single value of pixel luminosity. In light of the present disclosure, those in the art will understand that RGB-derived perceptible designs are equally effective as those created by approaches focusing on luminosity.

Persons of skill in the art will further appreciate that the teachings of this invention, while described in the context of creating a two-dimensional perceptible design, may be extended to apply to the creation of three-dimensional perceptible artifacts. A modifiable three-dimensional workpiece representation may be algorithmically inserted into three dimensional representations containing representations of target objects, such as in a point-cloud. The iterative modification of the workpiece, comprising workpiece insertion, object classification, loss calculation and workpiece manipulation, as taught by this disclosure, can be generalized to the three-dimensional space, whereby a three-dimensional model of a perceptible artifact may be derived.

The foregoing disclosure describes only certain embodiments of the invention. Accordingly, the present invention is not intended to be limited to the specific forms set forth herein, but on the contrary, it is intended to cover such alternatives, modifications and equivalents as can be reasonably included within the scope of the invention. The invention is limited only by the following claims and their equivalents.

I claim:

1. A method of creating a perceptible design to enhance identification by detectors of objects in a target class, comprising:
creating a test dataset by:
providing a plurality of obfuscated photographs, each photograph comprising one or more target class object images;
for each target class object image in each photograph, creating a bounding box therein, labeling the target class object image as an object in the target class;
providing a workpiece image comprised of pixels;
iterating:
for each target class object image in each photograph of the test dataset:
scaling the workpiece image to fit the bounding box of the target class object image;
inserting the workpiece image in the bounding box,
thereby creating a workpiece-inserted dataset;
submitting the workpiece-inserted dataset to one or more object detectors to produce target class classification values;
calculating a total loss function from the target class classification values;
for each pixel in the workpiece image:
applying gradient decent to change the pixel to minimize the total loss function,
thereby creating a new workpiece image for further iteration,
until loss is minimized by the new workpiece image which thereby emerges as the perceptible design.

2. The method of creating a perceptible design according to claim 1, wherein providing the plurality of obfuscated photographs comprises selecting photographs in which the one or more target class object images are obscured.

3. The method of creating a perceptible design according to claim 1, wherein providing the plurality of obfuscated photographs comprises selecting a plurality of photographs comprising the one or more target class object images and then obfuscating photographs in the plurality of photographs.

4. The method of creating a perceptible design according to claim 3, wherein obfuscating photographs in the plurality of images comprises at least one of folding, varying contrast, varying brightness, inserting noise, varying tint and varying color saturation of the photographs.

5. The method of creating a perceptible design according to claim 1, in which providing the workpiece image consists of selecting a pre-existing digital image.

6. The method of creating a perceptible design according to claim 1, in which providing the workpiece image comprises creating a new digital image.

7. The method of creating a perceptible design according to claim 6, in which providing the workpiece image comprises creating an image of random pixels.

8. The method of creating a perceptible design according to claim 1, wherein, for each target class object image in each photograph in the test dataset, iterating further comprises obfuscating the workpiece image prior to scaling the workpiece image to fit the bounding box of the target class object image.

9. The method of creating a perceptible design according to claim 1, wherein submitting the workpiece-inserted dataset to one or more object detectors comprises submitting the workpiece-inserted dataset to a random panel of object detectors.

10. A perceptible design enhancing identification by detectors of objects in a target class, created by:
creating a test dataset by:
providing a plurality of obfuscated photographs, each photograph comprising one or more target class object images;
for each target class object image in each photograph, creating a bounding box therein, labeling the target class object image as an object in the target class;
providing a workpiece image comprised of pixels;
iterating:
for each target class object image in each photograph of the test dataset:
scaling the workpiece image to fit the bounding box of the target class object image;
inserting the workpiece image in the bounding box,
thereby creating a workpiece-inserted dataset;
submitting the workpiece-inserted dataset to one or more object detectors to produce target class classification values;
calculating a total loss function from the target class classification values;
for each pixel in the workpiece image:
applying gradient decent to change the pixel to minimize the total loss function,
thereby creating a new workpiece image for further iteration,
until loss is minimized by the new workpiece image which thereby emerges as a perceptible design.

11. An article of manufacture bearing a perceptible design enhancing detection by detectors of objects in a target class, created by:
creating a test dataset by:
providing a plurality of obfuscated photographs, each photograph comprising one or more target class object images;
for each target class object image in each photograph, creating a bounding box therein, labeling the target class object image as an object in the target class;
providing a workpiece image comprised of pixels;
iterating:
for each target class object image in each photograph of the test dataset:
scaling the workpiece image to fit the bounding box of the target class object image;
inserting the workpiece image in the bounding box,
thereby creating a workpiece-inserted dataset;
submitting the workpiece-inserted dataset to one or more object detectors to produce target class classification values;
calculating a total loss function from the target class classification values;
for each pixel in the workpiece image:
applying gradient decent to change the pixel to minimize the total loss function,
thereby creating a new workpiece image for further iteration,
until loss is minimized by the new workpiece image which thereby emerges as a perceptible design,
and affixing the perceptible design to the article of manufacture.

12. An article of manufacture according to claim 10, wherein the article of manufacture is an article of clothing and the objects in the target class are human beings.
